(19) United States
(12) Patent Application Publication
(10) Pub. No.: US 2020/0207313 A1
(43) Pub. Date: Jul. 2, 2020

(54) METHOD FOR CONTROLLING AT LEAST ONE WASHING DEVICE OF AT LEAST ONE SENSOR SITUATED ON AN OUTER CONTOUR OF A VEHICLE

(71) Applicant: Robert Bosch GmbH, Stuttgart (DE)

(72) Inventors: Kai Clemens Liebich, Tuebingen (DE); Markus Koberstaedt, Buehl (DE); Zakarya Bamohamed, Strasbourg (FR)

(21) Appl. No.: 16/633,862

(22) PCT Filed: May 24, 2018
(86) PCT No.: PCT/EP2018/063670

§ 371 Date: Jan. 24, 2020

(30) Foreign Application Priority Data
Jul. 28, 2017 (DE) 10 2017 213 019.9

(51) Int. Cl. B60S 3/04; B60S 1/56

(52) U.S. Cl. CPC B60S 3/04; B08B 3/02; B60S 1/56

(57) ABSTRACT

In the method for controlling at least one washing device of at least one sensor situated on an outer contour of a vehicle, a completed vehicle wash of the outer contour of the vehicle is initially recognized. In this case, “sensors,” for example, are distance sensors, which detect the surroundings of a vehicle and are situated for this purpose on the outer body of the vehicle. As a result of a completed vehicle wash, the externally mounted sensors are cleaned as well and, therefore, after a vehicle wash, it may be assumed that these sensors are now free of dirt. First control signals for actuating the at least one washing device of the at least one sensor are generated depending on a recognized vehicle wash, which was carried out, for example, in a car wash.

### FIELD

The present invention describes a method, a processing unit, and a vehicle for controlling at least one washing device of at least one sensor situated on an outer contour of the vehicle.

### BACKGROUND INFORMATION

Washing devices for sensors are available in the related art. German Patent Application No. DE 10 2010 055 113 A1, for example, describes a cleaning device, which encompasses a spray nozzle, whose spraying area is directed toward a surroundings sensor. Such washing devices are very important, since dirty sensors may result in a great loss of sensor accuracy. For example, a dirty diaphragm of an ultrasonic sensor may make it more difficult for the diaphragm to oscillate. A dirty lens of a camera may cause the camera to provide inaccurate images.

Methods for recognizing a performed vehicle wash are also available in the related art. The purpose of this recognition, for example, is to prevent the wiper system from switching on automatically when the vehicle is located in a car wash. German Patent No. DE 698 09 508 T2 describes, for example, how a fold-up of the side mirror is used as an indication that the vehicle may be located in a car wash and, thereafter, the windshield wiper is switched off.

One object of the present invention is to provide a method and a device, which improves the efficiency of the use of a washing device for sensors.

### SUMMARY

In accordance with the present invention, a method and a processing unit are provided for controlling at least one washing device of at least one sensor situated on an outer contour of the vehicle. In addition, a vehicle is provided, which encompasses the processing unit according to the present invention.

In an example method according to the present invention for controlling at least one washing device of at least one sensor situated on an outer contour of a vehicle, a completed vehicle wash of the outer contour of the vehicle is initially recognized. In this case, “sensors” mean, for example, distance sensors, which detect the surroundings of a vehicle and are situated for this purpose on the outer body of the vehicle. As a result of a completed vehicle wash, the externally mounted sensors are cleaned as well and, therefore, after a vehicle wash, it may be assumed that these sensors are now free of dirt. According to the present invention, first control signals for actuating the at least one washing device of the at least one sensor are generated depending on a recognized vehicle wash, which was carried out, for example, in a car wash. Preferably, the first control signals are generated in such a way that the at least one washing device of the at least one sensor is temporarily switched off depending on a recognized completed vehicle wash. Therefore, for example, spray water for the nozzles of a sensor washing device may be conserved.

Moreover, the time is preferably recorded depending on such a switching-off of the at least one sensor washing device. Depending on the time recording, the method is started from the beginning again and the at least one washing device is switched on again if no further completed vehicle wash is recognized within a predefined first time period. Therefore, a situation is responded to, in which the owner of the vehicle has his/her vehicle washed often, so that a sufficient level of cleanliness of the at least one sensor may be guaranteed solely for this reason. The washing device needs to be switched on again only for the case in which no further vehicle wash was carried out within a certain time, for example, within a week. Alternatively, for this purpose, the time is preferably also recorded depending on such a switching-off of the at least one sensor washing device. In this case, however, regardless of whether a further vehicle wash was carried out or not, the at least one washing device of the at least one sensor is switched on again, in any case, if the recorded time exceeds a predefined second safety-critical time period. Therefore, the surety of a low level of dirt on a sensor is enhanced and, therefore, increased sensor accuracy is guaranteed.

Preferably, surroundings information of the vehicle is also gathered and, on the basis thereof, it is ascertained whether a situation is present, which indicates an increased risk for dirt on the at least one sensor situated on the outer contour of the vehicle. Such a situation may represent, for example, travel over a muddy surface. The at least one sensor washing device is switched on again depending on such a recognized situation. In this way as well, surety of a low level of dirt on a sensor is enhanced and, therefore, increased sensor accuracy is guaranteed.

Preferably, a situation may be recognized, which represents an increased risk for dirt on the at least one sensor situated on the outer contour of the vehicle, also depending on a detected activation of a windshield cleaning device and/or a detected activation of a rear window cleaning device of the vehicle. In this case, it is assumed that the dirt, which was removed with the aid of the activated windshield cleaning device, is also present on the at least one sensor on the outer contour of the vehicle. The at least one washing device is switched on again depending on such a recognized situation.

Preferably, at least one motion of at least one wiper arm of a vehicle windshield wiper is detected. In this case, advantage is taken of the circumstances that, when the brushes of a car wash rotate across the automobile, the brushes, inter alia, pull on the wiper arms. This pulling results in a slight change in the angle of the wiper arms and, therefore, a motion. In order to ensure, however, that this is actually a recognized vehicle wash, at least one operating variable of the vehicle is also detected. The operating variable is a variable, which characterizes the present operation of the vehicle. This is, for example, the present steering angle and/or the speed of the first vehicle. Depending on the detected motion of the at least one wiper arm and the detected at least one operating variable, a completed vehicle wash is subsequently recognized. Therefore, the sensitivity for recognizing a vehicle wash and, therefore, also the surety of a low level of dirt on a sensor are enhanced. Preferably, the detected operating variable of the vehicle is a detected rotational speed of at least one wheel of the vehicle. Therefore, it may be ensured that the vehicle is at a standstill and, on the basis thereof, in turn, it may be better inferred whether the detected motion of the wiper arm is due, for example, to wind or was actually detected due to a vehicle wash.

The present invention also relates to a processing unit, which is designed for carrying out the method according to the present invention.

Additionally, the present invention relates to a vehicle, such as a motor vehicle, which encompasses the processing unit. The vehicle also encompasses at least one sensor situated on the outer contour of the vehicle. This may be, for example, a distance sensor for parking. Moreover, the vehicle encompasses at least one washing device for the at least one sensor situated on the outer contour of the vehicle. This may be, for example, a spray water system for the sensor. The processing unit is designed, in this context, for recognizing a completed vehicle wash of the outer contour and, therefore, of the outer surface of the vehicle. Depending on the recognition of such a completed vehicle wash, the processing unit is designed for actuating the at least one washing device of the at least one sensor situated on the outer contour of the vehicle.

Preferably, the vehicle encompasses a first detection unit for detecting at least one motion of at least one wiper arm of a windshield wiper of the vehicle. This may be, for example, an acceleration sensor, which is situated at the wiper arm. Moreover, the vehicle encompasses a second detection unit for detecting at least one operating variable of the vehicle. This may be, for example, a speed sensor for a wheel of the vehicle. The processing unit is designed, in this case, for receiving the detected motion of the wiper arm and the detected operating variable and, depending on these detected variables, recognizing a completed vehicle wash.

Preferably, moreover, the vehicle additionally encompasses a third detection unit for recording the time. This may be a clock. The processing unit is designed for generating first control signals for actuating the at least one sensor washing device in such a way that the at least one washing device of the at least one sensor is temporarily switched off upon recognition of a completed vehicle wash. If the at least one washing device of the at least one sensor is switched off, the processing unit activates the third detection unit. Preferably, the vehicle additionally encompasses a fourth detection unit for detecting surroundings information of the vehicle. This may be, for example, a camera or a distance sensor. This may be, in particular, the same, at least one, sensor, whose washing device is controlled according to the present invention. The processing unit is designed, in this case, for recognizing a situation, which represents an increased risk for dirt on the at least one sensor situated on the outer contour of the vehicle depending on the gathered surroundings information and, depending on a recognized situation, switching on the at least one washing device again. Moreover, optionally, the processing unit is designed for recognizing a situation, which represents an increased risk for dirt on the at least one sensor situated on the outer contour of the vehicle depending on a detected activation of a windshield cleaning device and/or a detected activation of a rear window cleaning device of the vehicle.

### BRIEF DESCRIPTION OF THE DRAWINGS

FIG. 1 schematically shows a vehicle according to the present invention.

FIG. 2 shows a specific embodiment of the processing unit according to the present invention.

FIG. 3a shows a first method sequence according to the present invention for controlling at least one washing device of at least one sensor situated on an outer contour of a vehicle.

FIG. 3b shows a second method sequence according to the present invention for controlling at least one washing device of at least one sensor situated on an outer contour of a vehicle.

### DETAILED DESCRIPTION OF EXAMPLE EMBODIMENTS

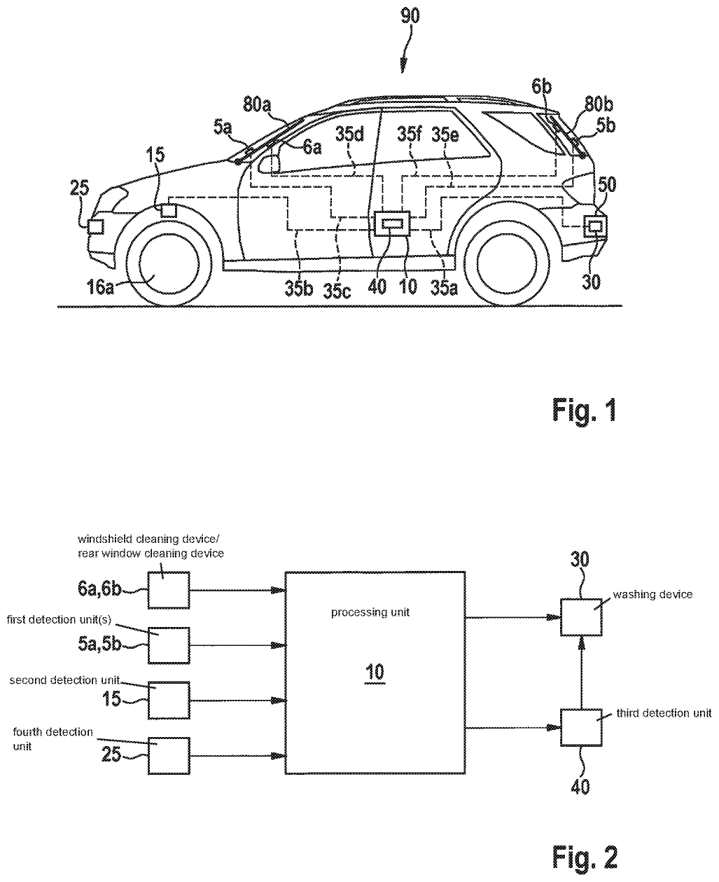

FIG. 1 schematically shows a vehicle 90 encompassing a processing unit 10 according to the present invention. Additionally, the vehicle encompasses a sensor 50 situated on the outer contour of vehicle 90 and a washing device 30 for this sensor 50. In this context, a data link 35a is represented between processing unit 10 and washing device 30, whereby processing unit 10 may transmit first control signals to washing device 30. Optionally, vehicle 90 also encompasses a first detection unit 5a and/or 5b for detecting at least one motion of a wiper arm 80a and/or 80b of vehicle 90 and a second detection unit 15 for detecting at least one operating variable of vehicle 90. In this case, wiper arm 80a represents a wiper arm of the front windshield wiper and wiper arm 80b represents a wiper arm of the rear window wiper. In this FIG. 1, second detection unit 15 is a speed detection unit for a wheel 16a of vehicle 90. Moreover, in this context, a data link 35c and a data link 35e are represented between first detection unit 5a and/or 5b to processing unit 10, whereby processing unit 10 may receive the detected wiper arm motion. Moreover, in this context, a data link 35b is represented between second detection unit 15 and processing unit 10, whereby processing unit 10 may receive the detected operating variable. Moreover, optionally, the vehicle encompasses a third detection unit 40, which is integrated into processing unit 10 in this FIG. 1. Third detection unit 40 is, in particular, a clock. Moreover, vehicle 90 optionally encompasses a fourth detection unit 25 for detecting surroundings information of vehicle 90. Moreover, optionally, the front windshield wiper and/or the rear window wiper encompass/encompasses a windshield cleaning device 6a and/or a rear window cleaning device 6b. Moreover, in this context, a data link 35d and a data link 35f are represented between windshield cleaning device 6a and/or rear window cleaning device 6b to processing unit 10, whereby processing unit 10 may receive a detected activation signal of windshield cleaning device 6a and/or rear window cleaning device 6b.

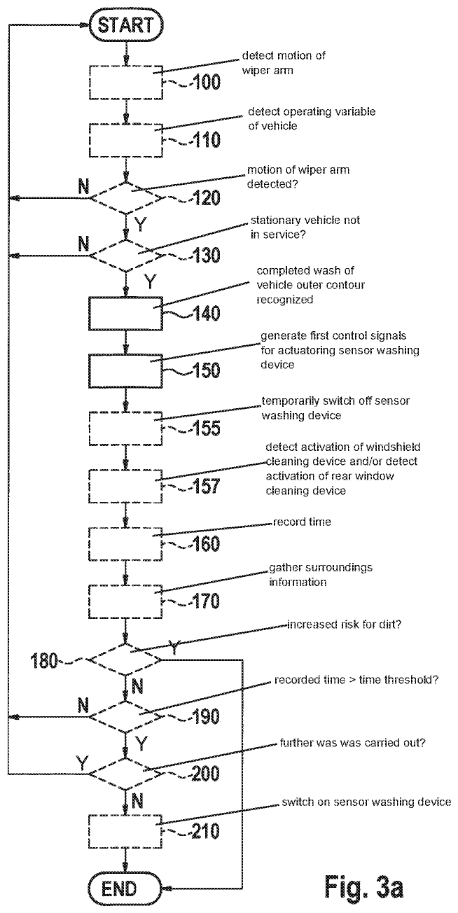

FIG. 2 shows a specific embodiment of processing unit 10 according to the present invention for controlling at least one washing device 30 of at least one sensor 50 situated on an outer contour of a vehicle. Processing unit 10 is designed, in this case, for recognizing a completed vehicle wash of the outer contour of the vehicle and, depending on a recognized vehicle wash, generating first control signals for actuating at least one washing device 30 of at least one sensor situated on the outer contour. Optionally, processing unit 10 is designed, in this context, for generating the first control signals depending on a recognized vehicle wash in such a way that the at least one sensor washing device is temporarily switched off. Optionally, processing unit 10 is also designed for generating, depending on a shut-off of the at least one sensor washing device, second control signals for actuating a third detection unit 40 for recording the time.

Optionally, processing unit 10 is designed for detecting at least one motion of at least one wiper arm of a windshield wiper of the vehicle with the aid of a first detection unit 5. Moreover, processing unit 10 is optionally designed for receiving at least one operating variable of the vehicle from a second detection unit 15. Depending on the received motion of the at least one wiper arm and the detected at least one operating variable of the vehicle, processing unit 10 recognizes a completed vehicle wash.

Optionally, processing unit 10 is designed for receiving gathered surroundings information of the vehicle from a fourth detection unit 40 and, depending on the gathered surroundings information, recognizing a situation, which represents an increased risk for dirt on the at least one sensor situated on the outer contour of the vehicle. Processing unit 10 is also designed for switching on the at least one washing device again depending on a recognized situation.

Optionally, processing unit 10 is designed for receiving detected activation signals of a windshield cleaning device 6a and/or a rear window cleaning device 6b of the vehicle and, depending on the detected activation signals, recognizing a situation, which represents an increased risk for dirt on the at least one sensor situated on the outer contour of the vehicle. Processing unit 10 is also designed for switching on the at least one washing device again depending on a recognized situation.

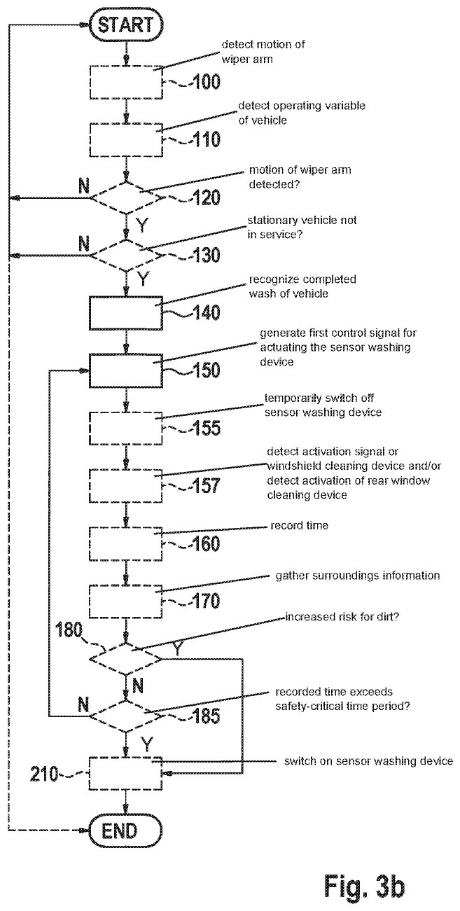

FIG. 3a shows a first specific embodiment of the method sequence according to the present invention for controlling at least one washing device of at least one sensor situated on an outer contour of a vehicle. In this case, in a first method step 140, a completed washing of the vehicle outer contour is recognized and, thereupon, in method step 150, first control signals are generated for actuating the at least one sensor washing device depending on a recognized completed vehicle wash.

Optionally, the first control signals are generated in such a way that the at least one sensor washing device is temporarily switched off in a subsequent method step 155.

Thereupon, the method is terminated.

Moreover, the recognition of a completed vehicle wash takes place by additional optional method steps. In this process, in a method step 100, at least one motion of a wiper arm of a windshield wiper of the vehicle is detected and, in a subsequent method step 110, at least one operating variable of the vehicle is detected. If it is established in method step 120 that a motion of the wiper arm was detected and if it is additionally established in method step 130 that the detected operating variable of the vehicle indicates a stationary vehicle not in service, a completed wash of the vehicle outer contour is recognized in method step 140. Optionally, the at least one operating variable of the vehicle represents a detected rotational speed of at least one wheel of the vehicle.

Moreover, optionally, following the shut-off of the sensor washing device in method step 155, the time is recorded in method step 160 and this recorded time is compared to a first time threshold in method step 190. If it is established that the third time threshold has not yet been exceeded, the method is started again from the beginning. If the time threshold is finally exceeded, a check is carried out in following method step 200 to determine whether a further wash was carried out during the time. If a further wash of the vehicle outer contour was carried out, the sensor washing device remains switched off and the method starts from the beginning or, optionally, is terminated. However, if no further vehicle wash was established, the at least one sensor washing device is switched on again in following method step 210.

Moreover, optionally, in a method step 170 following method step 150, surroundings information is gathered and a check is carried out in a following method step 180 to determine whether a situation may be ascertained from the gathered surroundings information, which represents an increased risk for dirt on the at least one sensor situated on the outer contour of the vehicle. If a muddy surface is detected, for example, with the aid of a camera, this may infer that there is an increased risk for dirt on the sensor. Travel on a wet expressway, in the case of which a preceding vehicle throws road spray back onto the relevant vehicle, may also result in such a situation, for example. Optionally, in order to check whether a situation is present, which represents an increased risk for dirt on the at least one sensor situated on the outer contour of the vehicle, at least one activation signal of a windshield cleaning device and/or a detected activation of a rear window cleaning device of the vehicle is detected in method step 157. If a predefined number of activation signals is detected within a predefined third time period, it may be assumed that the vehicle is considerably covered in dirt and this dirt is therefore also located on the sensors. Correspondingly, a situation would be present in this case, which indicates an increased risk for dirt on the sensor.

FIG. 3b shows a second specific embodiment of the method according to the present invention for controlling at least one washing device of at least one sensor situated on an outer contour of a vehicle.

In this case, in contrast to the method sequence from FIG. 3a, a check is carried out in a method step 185 following method step 180 to determine whether the recorded time exceeds a predefined second safety-critical time period. If the time does not exceed this second time period, first control signals are generated in method step 150 for switching off the at least one sensor washing device. Finally, if the recorded time exceeds the second safety-critical time period, the at least one sensor washing device is switched on again in method step 210.

1-15. (canceled)

16. A method for controlling at least one washing device of at least one sensor situated on an outer contour of a vehicle, the method comprising the following steps:
recognizing a completed vehicle wash of the outer contour of the vehicle;
generating first control signals for actuating the at least one washing device of the at least one sensor situated on the outer contour of the vehicle depending on the recognized completed vehicle wash.

17. The method as recited in claim 16, wherein the first control signals for actuating the at least one washing device are generated in such a way that the at least one washing device of the at least one sensor is temporarily switched off depending on the recognized completed vehicle wash.

18. The method as recited in claim 16, wherein the recognition of the completed vehicle wash takes place using the following method steps:
detecting at least one motion of at least one wiper arm of a windshield wiper of the vehicle;
detecting at least one operating variable of the vehicle;
recognizing the completed vehicle wash depending on the detected motion of the at least one wiper arm and the detected at least one operating variable of the vehicle.

19. The method as recited in claim 18, wherein the at least one detected operating variable of the vehicle represents a detected rotational speed of at least one wheel of the vehicle.

20. The method as recited in claim 17, further comprising the following steps:
recording a time depending on a shut-off of the at least one washing device of the at least one sensor;
wherein the method starts again from a beginning of the method depending on the time recording and the at least one washing device of the at least one sensor being switched on again if no further completed vehicle wash is recognized within a predefined first time period.

21. The method as recited in claim 17, further comprising the following steps:
recording a time depending on a shut-off of the at least one washing device of the at least one sensor;
wherein the at least one washing device of the at least one sensor is switched on again if the recorded time exceeds a predefined second safety-critical time period.

22. The method as recited in claim 17, further comprising the following steps:
gathering surroundings information of the vehicle;
recognizing a situation, which represents an increased risk for dirt on the at least one sensor situated on the outer contour of the vehicle, depending on the gathered surroundings information; and
switching on the at least one washing device depending on the recognized situation.

23. A processing unit configured to control at least one washing device of at least one sensor situated on an outer contour of a vehicle, the processing unit configured to:
recognize a completed vehicle wash of the outer contour of the vehicle; and
generate first control signals for actuating the at least one washing device of the at least one sensor situated on the outer contour of the vehicle depending on a recognized completed vehicle wash.

24. The processing unit as recited in claim 23, wherein the processing unit is further configured to:
receive at least one motion of at least one wiper arm of a windshield wiper of the vehicle from a first detection unit;
receive at least one operating variable of the vehicle from a second detection unit; and
recognize the completed vehicle wash depending on the received motion of the at least one wiper arm and the detected at least one operating variable of the vehicle.

25. The processing unit as recited in claim 23, wherein the processing unit is configured to generate the first control signals for actuating the at least one washing device in such a way that the at least one washing device of the at least one sensor is temporarily switched off depending on a recognized completed vehicle wash.

26. The processing unit as recited in claim 24, wherein the processing unit is further configured to:
generating second control signals for actuating a third detection unit for recording a time depending on a shut-off of the at least one washing device of the at least one sensor.

27. A motor vehicle, comprising:
a processing unit;
at least one sensor situated on an outer contour of the vehicle; and
at least one washing device for the at least one sensor situated on the outer contour of the vehicle;
wherein the processing unit is configured to recognize a completed wash of an outer contour of the vehicle, and, depending on a recognized completed vehicle wash, actuate the at least one washing device of the at least one sensor situated on the outer contour of the vehicle.

28. The vehicle as recited in claim 27, further comprising:
a first detection unit configured to detect at least one motion of at least one wiper arm of a windshield wiper of the vehicle; and
a second detection unit configured to detect at least one operating variable of the vehicle;
wherein the processing unit is configured to receive the detected at least one motion of the at least one wiper arm and the at least one operating variable of the vehicle, and is configured to recognize the completed vehicle wash depending on the received motion of the at least one wiper arm and the detected at least one operating variable of the vehicle.

29. The vehicle as recited in claim 27, further comprising;
a third detection unit configured to record a time;
wherein the processing unit is configured to generate first control signals for actuating the at least one washing device in such a way that the at least one washing device of the at least one sensor is switched off depending on a recognized completed vehicle wash and to actuate the third detection unit depending on a shut-off of the at least one washing device of the at least one sensor.

30. The vehicle as recited in claim 29, wherein the third detecting unit includes a clock.

31. The vehicle as recited in claim 27, further comprising:
a fourth detection unit configured to gather surroundings information of the vehicle;
wherein the processing unit is configured to recognize a situation, which represents an increased risk for dirt on the at least one sensor situated on the outer contour of the vehicle, depending on the gathered surroundings information and, depending on a recognized situation, switching on the at least one washing device.
